(19) United States
(12) Patent Application Publication
(10) Pub. No.: US 2010/0083670 A1
(43) Pub. Date: Apr. 8, 2010

(54) METHOD FOR VAPORIZING AND HEATING CRYCOGENIC FLUID

(76) Inventors: Sunil Dutt, Katy, TX (US); Crystal Elaine Ramon, Houston, TX (US)

Correspondence Address: CHEVRON CORPORATION, P.O. BOX 6006, SAN RAMON, CA, 94583-0806, US

(21) Appl. No.: 12/567,041

(22) Filed: Sep. 25, 2009

Related U.S. Application Data
(63) Continuation of application No. 11/442,058, filed on May 26, 2006, now abandoned.

(51) Int. Cl. F17C 9/02

(52) U.S. Cl. 62/50.2

(57) ABSTRACT

A method for vaporizing and heating a cryogenic fluid such as a liquefied natural gas, to a desired temperature in the ambient temperature range. The method comprises using an intermediate heat exchange fluid such as propane to heat the liquefied natural gas and to utilize the cold potential of the liquefied natural gas to produce power. The heat exchange fluid is heated by a heat source, such as warm or hot water available from an industrial process. The heat exchange fluid is pressurized and heated to form a heat exchange vapor. The heat exchange vapor is split into multiple streams that exchange heat with the cryogenic fluid in series fashion so that the cryogenic fluid is vaporized and heated to the desired temperature in stages using a common heat exchange fluid and heat source.

### CROSS-REFERENCE TO RELATED APPLICATION

This application is a Continuation of and claims priority to U.S. Ser. No. 11/442,058 which was filed on May 26, 2006 and which is hereby incorporated by reference in its entirety.

### FIELD OF THE INVENTION

The present invention relates to the field of cryogenic fluids, and more particularly, to the transmission and vaporization of liquefied gases. The methods of the present invention utilize a heat exchange fluid within a closed loop that can be heated with relatively low temperature heat to gasify a liquefied natural gas (LNG) and warm the gasified LNG to a temperature suitable for pipeline transmission. The methods of the present invention can also produce by-product power to enhance efficiency.

### BACKGROUND OF THE INVENTION

Natural gas is often discovered and produced in locations that are remote from where the gas can be marketed and distributed to end users. When suitable pipelines are available natural gas can be transported to market in either a gaseous or liquid form, however, there are many instances in which such pipelines are not available or practical for connecting a particular natural gas supply with consumers.

When natural gas supplies are located overseas or a substantial distance from a suitable distribution system, it may be necessary to transport the gas by vessel. Such vessels typically include specially designed carriers that transport natural gas as a liquid housed in large insulated containers or tanks.

When transported at or near atmospheric pressure liquefied natural gas (LNG) is held at temperatures slightly below about −164° C. This temperature represents the boiling-point temperature for methane at atmospheric pressure. However, since the composition of natural gas will typically contain variable amounts of heavier and higher boiling hydrocarbons such as ethane, propane, butane and the like, the liquefied gas will be characterized by a somewhat higher boiling temperature, usually ranging from about −151° C. to about −164° C. depending upon composition. At or near a destination, the LNG must be regasified and warmed before it can be introduced into a distribution pipeline. In addition, depending on the requirements of the pipeline and local natural gas specifications, the LNG may be pressurized, depressurized, blended, odorized or subjected to other processing before it can be introduced into a pipeline or similar distribution system.

Systems for regasifying LNG can be utilized both on and off-shore. For instance, vaporizers used to heat LNG to a vaporization temperature can be employed on-board an LNG carrier, on a structure or vessel floating near the carrier, on a bottom founded structure, or in land-based facilities. Vaporizers typically regasify the LNG by heating it with a warm fluid such as ambient air, sea water or other heat exchange fluid(s), which may be heated by burning fuel gas. In addition, attempts have been made to capture the potential of the LNG cold by using the cold to assist in refrigeration and chilling applications and in some cases to generate power.

### SUMMARY OF THE INVENTION

In one embodiment, the present invention relates to a method for vaporizing and heating a cryogenic fluid. The method includes the steps of producing a high pressure heat exchange vapor from a heat exchange fluid, splitting the high pressure heat exchange vapor into a first heat exchange stream and a second heat exchange stream, reducing the pressure of the first stream by using the first heat exchange stream as a working fluid in a power generating device, exchanging heat between the first heat exchange stream and a cryogenic fluid to at least partially vaporize the cryogenic fluid, exchanging heat between the second heat exchange stream and the partially vaporized cryogenic fluid to heat the vaporized cryogenic fluid to a minimum temperature; adjusting the pressure of one or more of the first and second heat exchange streams; and re-combining the first and second heat exchange streams to produce the heat exchange fluid. In such an embodiment, the cryogenic fluid can be liquefied natural gas and the heat exchange fluid can include one or more of ethane, propane, butane, ethylene and propylene. A high pressure heat exchange vapor can be produced from the heat exchange fluid by pumping the heat exchange fluid to a higher pressure and then heating the heat exchange fluid. The method can optionally include the step of increasing the pressure of the cryogenic fluid to a pressure of at least about 500 psig, prior to exchanging heat with the first stream. The cryogenic fluid can be vaporized and heated to a minimum temperature of at least about −6.67° C., and more preferably to a minimum temperature of at least about 4.44° C.

In another embodiment, the present invention relates to a method for vaporizing and heating a liquefied natural gas. The method includes the steps of producing a heat exchange vapor from a heat exchange fluid that comprises propane, splitting the heat exchange vapor into a first heat exchange stream and a second heat exchange stream, reducing the pressure of the first heat exchange stream by using the first heat exchange stream as a working fluid in a power generating device, exchanging heat between the first heat exchange stream and liquefied natural gas to at least partially vaporize the liquefied natural gas, exchanging heat between the second heat exchange stream and the partially vaporized liquefied natural gas to heat the vaporized liquefied natural gas to a minimum temperature, adjusting the pressure of one or more of the first and second heat exchange streams, and re-combining the first and second heat exchange streams to produce the propane fluid. Such a method can optionally include increasing the pressure of the liquefied natural gas to a pressure of at least about 500 psig prior to exchanging heat with the first heat exchange stream. Producing a high pressure heat exchange vapor can include first pumping the heat exchange fluid to a higher pressure and then heating the heat exchange fluid. The liquefied natural gas is vaporized and heated to a minimum temperature of at least about −6.67° C. The step of adjusting the pressure of one or more of the first heat exchange stream and the second heat exchange stream can include one or more of increasing the pressure of the first heat exchange stream, reducing the pressure of the second heat exchange stream, and increasing the pressure of the second heat exchange stream.

In yet another embodiment, the present invention relates to a method for vaporizing and heating a cryogenic fluid. The method includes the steps of producing a heat exchange vapor from a heat exchange fluid, splitting the heat exchange vapor into a first heat exchange stream and a second heat exchange stream, exchanging heat between the first heat exchange stream and a cryogenic fluid to at least partially vaporize the cryogenic fluid, exchanging heat between the second heat exchange stream and the partially vaporized cryogenic fluid to heat the vaporized cryogenic fluid to a minimum temperature, adjusting the pressure of one or more of the first heat exchange stream and the second heat exchange stream; and re-combining the first and second heat exchange streams to produce the heat exchange fluid. The heat exchange fluid can comprise propane and the cryogenic fluid can comprise a liquefied gas such as liquefied natural gas. Optionally, the method can comprise the step of adjusting the pressure of one or more of the first and second heat exchange streams can comprise reducing the pressure of the second heat exchange stream after exchanging heat with the partially vaporized cryogenic fluid.

### BRIEF DESCRIPTION OF THE DRAWINGS

The invention may be understood by reference to the following description taken in conjunction with the accompanying drawings.

FIG. 1 is a schematic view illustrating a system that could be used to perform a method of the present invention.

FIG. 2 is a schematic view illustrating a system that could be used to perform a method of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

The present invention relates to various methods for efficiently vaporizing liquefied natural gas (LNG) and warming the resulting natural gas for further processing, storage, transport or end use. It is known that LNG terminals require a significant amount of heat to vaporize the LNG. In the methods of the present invention, an intermediate heat exchange fluid exchanges heat with the LNG to vaporize the LNG and to further heat it to a desired temperature. By vaporizing the LNG with a first portion of the heat exchange fluid and then heating the vaporized gas with a second portion of the heat exchange fluid, an improved conversion is achieved. As a result, the heat exchange fluid can be heated to suitable temperatures with either a high or low grade heat source(s). Examples of suitable low grade heat sources include cooling water streams from a refinery or other industrial processes, as well as ambient air and water. Suitable high grade heat sources can include fluids that have been heated such as by burning fuel gas.

The methods of the present invention can optionally include recovering the cold potential of the LNG such as by generating power or extracting work from the heat exchange fluid using a Rankine cycle to further enhance the efficiency of the system. For instance, where power is generated using the heat exchange fluid as the working fluid, the generated power is available to meet the power requirements of the system, thereby reducing or even eliminating the need for less efficient on-site power generation technologies and/or the consumption of power from external sources. Moreover, in contrast to many power generating technologies, power generation using the cold potential of the LNG will generally have significantly lower emissions.

The methods of the present invention can be used in the vaporization and heating of any cryogenic fluid. For purposes of this disclosure, a cryogenic fluid is a liquid phase fluid that must be maintained at sub-ambient temperatures (i.e. temperatures of less than about 25° C.) and/or at a super-ambient pressure (i.e. a pressure greater than about 15 psia) to remain in the liquid phase. Liquefied natural gas is a cryogenic fluid that comprises methane and typically small amounts of higher molecular weight hydrocarbons and other components. As noted above, the boiling or vaporization point of the liquefied natural gas will vary depending on composition.

Where the pressure of the cryogenic fluid needs to be increased for its intended use, it is preferred that the fluid be pressurized prior to vaporization. In an embodiment where the cryogenic fluid is a liquefied natural gas, the natural gas will be substantially in the liquid phase and typically stored at a pressure above about 1 atmosphere. Where the product natural gas is intended for pipeline transport, following vaporization and heating the natural gas should be at a relatively high pressure, above about 500 psig, preferably above about 1000 psig, and more preferably above about 1200 psig. In addition, the temperature of the natural gas product will preferably be at a temperature in the ambient temperature range, and more specifically, at least about −6.67° C. and more preferably at least about 4.44° C. At such elevated pressures and temperatures, the natural gas product is considered a dense phase material.

A heat exchange fluid is used in the methods of the present invention as an intermediate heat exchange fluid to transfer heat from a heat source to the cryogenic fluid. Optionally, a portion of the energy transferred to the heat exchange fluid from the heat source can be extracted in the form of power or work.

The heat exchange fluid is generally selected for particular properties that will meet the needs of a particular application of the method. Cost and safety are primary considerations. The heat exchange fluid should be selected so that it has a suitably low freezing point so that it does not solidify when exchanging heat with the cryogenic fluid and does not cause the heat source to freeze when exchanging heat with the heat source. Moreover, during operation, the temperature of the heat exchange fluid must be below the temperature of the heat source.

It is preferred that the selected heat exchange fluid will undergo at least partial phase changes during circulation with a resulting transfer of latent heat. For example, the heat exchange fluid will preferably have moderate vapor pressure at a temperature between the actual temperature of the heat source and the freezing temperature of the heat source such that the heat exchange fluid will vaporize during heat exchange with the heat source. Further, in an embodiment where the cryogenic fluid is a liquefied natural gas, the heat exchange fluid should be liquefiable at a temperature above the boiling temperature of the liquefied natural gas, such that the heat exchange fluid will condense during heat exchange with the liquefied natural gas.

The heat exchange fluid can be a pure material or a mixture of different heat exchange fluids that yields a composition having desired thermal properties. Exemplary heat exchange fluids include hydrocarbons having 1 to 6 carbon atoms per molecule such as propane, ethane, ethylene, propylene, and methane, and mixtures thereof. In an embodiment, where the cryogenic fluid is liquefied natural gas, the heat exchange fluid is preferably selected from ethane, propane, butane, and mixtures thereof, particularly since such fluids are typically present in at least minor amounts in natural gas, and thus, are readily available. Other heat exchange fluids that may be useful in the methods of the present invention include commercial refrigerants and halogenated carbons such as chlorofluorocarbons, which have excellent thermal and oxidation properties for this use. Environmentally friendly fluids are particularly desirable. Even higher freezing point fluids such as water may be used as the heat exchange fluid provided the system is designed to reduce the tendency of the water to freeze at the temperatures of the cryogenic fluids.

In the methods of the present invention, a heat exchange vapor is produced from the heat exchange fluid. The heat exchange vapor can be produced from the heat exchange fluid by pumping the heat exchange fluid to a higher pressure and/or heating the heat exchange fluid to a temperature at which the heat exchange fluid is fully vaporized. In an embodiment where power is to be generated or work extracted, a high pressure heat exchange vapor can be produced by first pumping the heat exchange fluid to a higher pressure and then heating the heat exchange fluid to an elevated pressure. The pressure and temperature required to vaporize the heat exchange fluid will depend on the composition of the fluid. Where the heat exchange fluid comprises propane the high pressure heat exchange vapor can be produced by first pumping the propane to a pressure of at least about 60 psig and then heating the propane fluid to a temperature of at least about 4.44° C.

Pumping or compressing the heat exchange fluid can be achieved using devices known for pumping and compressing fluids. The selection of a pumps and compression equipment will be a matter of design choice and will depend on factors such as the composition of the heat exchange fluid, its flow rate, the desired vaporization and/or condensation temperatures, and whether power is to be produced from the circulating heat exchange fluid. Because it is typically more efficient to increase the pressure of a liquid than a gas, there is a preference for increasing the pressure of the heat exchange fluid when it is primarily in a liquid phase. Suitable pumps can include centrifugal and reciprocating pumps. Of course, there may be particular applications of the present invention in which it is desirable to compress the heat exchange fluid when it is primarily in a gaseous state.

Heating the heat exchange fluid can be achieved by exchanging heat between a heat source and the heat exchange fluid. This heat exchange can occur in any conventional heat exchange device that is capable of at least partially vaporizing the heat exchange fluid given the properties of the selected heat source and heat exchange fluid. In one embodiment, thermal energy is supplied to a heat exchanger via a relatively hot liquid process stream such as heated stream of cooling water from a refinery or other petrochemical facility. In another embodiment, the heat source is a vapor stream that is cooled and/or condensed as thermal energy is exchanged with the heat exchange fluid. For cooling and/or condensing liquid or vapor streams, the selection and design of the heat exchanger is a matter of engineering choice. A shell and tube-type heat exchanger is one possible choice.

Suitable heat sources include ambient air, ground water, seawater, river water, waste or cooling water streams. In other embodiments, the heat source can include a combustor, such as a process boiler, process heater or a process furnace. In such cases, fuel is combusted to produce the heat that is used to heat the heat exchange fluid. It will be recognized by those skilled in the art that the choice of heat source for a given process will depend on a number of considerations. Moreover, the cooling and/or condensing of a stream that originates from a separate process (e.g. a refinery) may be desirable, particularly if the cooling provided by the heat exchange fluid can replace equipment required in the other process. Another consideration in selecting a heat source will be whether power and/or work is to be generated from the circulating heat exchange fluid, such as for instance by using the heat exchange fluid as a working fluid in a power generating device.

The heat exchange vapor is split into a first heat exchange stream and a second heat exchange stream. Valves, manifolds and other known flow control devices can be used to split the heat exchange vapor into two or more streams.

Where it is desirable to generate power or extract work, the circulating heat exchange fluid, such as in the form of a first or second heat exchange stream, can be used as a working fluid in a power generating device. Suitable power generating devices can include expansion turbines, condensing turbines, hydraulic expanders, reciprocating engines and the like, but can include any engine that operates by expansion of the vaporized heat exchange fluid. In an embodiment where the power generating device is an expansion turbine, the rotation of the turbine can be used to drive electrical generators or to drive associated equipment such as pumps or compressors. The expanded heat exchange stream exiting the turbine will exhibit reduced pressure. Typically, a cooling effect will also accompany the reduction in pressure of the heat exchange stream such that the exiting heat exchange stream will be substantially liquid, vapor, or some combination of liquid and vapor depending upon its composition and the resulting temperature and pressure. The amount of power generated will depend in part on the flow rate, pressure and temperature of the circulating heat exchange fluid. While higher temperatures and pressures are capable of generating more power, greater energy inputs are generally required to achieve such temperatures and pressures. As a result, the amount of power, if any, that is to be generated in a particular application will vary depending on factors such as the power requirements of the particular system, the composition and conditions of the circulating heat exchange fluid at the location where power is to be generated, and the availability and cost of power from other sources.

The cryogenic fluid exchanges heat with the heat exchange fluid in at least two separate and distinct steps. By splitting the heat exchange fluid into two or more separate streams and using the separate streams to exchange heat with the cryogenic fluid in series fashion, a more effective heat transfer to the cryogenic fluid is achieved. Heat can be exchanged between the cryogenic fluid and the first and second heat exchange streams in heat exchangers designed for low temperature operation and for high volume throughput. Heat exchangers known for such use are commonly referred to as vaporizers and can include shell and tube type exchangers, core-in-kettle type heat exchangers, and plate-fin type heat exchangers among others. It should be noted that although the heat exchanger or vaporizer may be referred to in a singular sense, that these terms are representative of multiple single pass heat exchangers, a single multi-pass heat exchanger, and combinations of the same.

In the first heating step, the cryogenic fluid exchanges heat with the first heat exchange stream at least partially vaporizing the cryogenic fluid. The cryogenic fluid is heated in this exchange to a temperature in an intermediate temperature range. In an embodiment where the cryogenic fluid comprises a liquefied natural gas and the first heat exchange stream comprises propane, the natural gas is heated to a temperature of at least about −73.33° C., and preferably at least about −45.56° C. This heat exchange partially vaporizes the liquefied natural gas and at least partially condenses the propane vapor in the first heat exchange stream. The condensed propane fluid can then be directed to a surge vessel or other container for holding a reserve of the heat exchange fluid.

In the second heating step, heat is exchanged between the second heat exchange stream and the partially vaporized cryogenic fluid to heat the vaporized cryogenic fluid to a minimum temperature. The minimum temperature is the temperature required of the cryogenic fluid by a downstream process, storage or pipeline. Where the cryogenic fluid comprises natural gas, the minimum temperature will be a temperature in the ambient temperature range, but will generally be at least about −6.67° C., preferably at least about 4.44° C. and more preferably at least about 15.56° C. During this heat exchange, the second heat exchange stream is subcooled by the partially vaporized cryogenic fluid.

The first and second heat exchange streams are then re-combined to produce the heat exchange fluid that will be used to form the heat exchange vapor. Prior to recombining the first and second heat exchange streams, the pressure of one or more of the first heat exchange stream and the second heat exchange stream may need to be adjusted so that the pressures of the first and second heat exchange streams are about the same. Adjusting the pressure of one or more of the first and second heat exchange streams can comprise one or more of increasing the pressure of the first heat exchange stream, reducing the pressure of the second heat exchange stream and increasing the pressure of the second heat exchange stream. Increases in pressure can be achieved by using pumps and compressors as described herein. Decreases in pressure can be achieved by directing the stream through a power generating device as described elsewhere herein or by other pressure reducing means known in the art such as throttle valves, e.g. a Joule-Thompson valve, flash vessels and the like.

In view of the above disclosure, one of ordinary skill in the art should understand and appreciate that the present invention includes many possible illustrative embodiments that depend on design criteria. One such illustrative embodiment includes a method for vaporizing and heating a cryogenic fluid. The method comprises the steps of producing a high pressure heat exchange vapor from a heat exchange fluid; splitting the high pressure heat exchange vapor into a first heat exchange stream and a second heat exchange stream; reducing the pressure of the first heat exchange stream by using the first heat exchange stream as a working fluid in a power generating device; exchanging heat between the first heat exchange stream and a cryogenic fluid to at least partially vaporize the cryogenic fluid; exchanging heat between the second heat exchange stream and the partially vaporized cryogenic fluid to heat the vaporized cryogenic fluid to a minimum temperature; adjusting the pressure of one or more of the first and second heat exchange streams; and re-combining the first and second heat exchange streams to produce the heat exchange fluid. In such an embodiment, the cryogenic fluid can comprise a liquefied natural gas and the heat exchange fluid can include one or more of ethane, propane, butane, ethylene and propylene. A high pressure heat exchange vapor can be produced from the heat exchange fluid by pumping the heat exchange fluid to a higher pressure and then heating the heat exchange fluid. The method can optionally include the step of increasing the pressure of the cryogenic fluid to a pressure of at least about 500 psig, prior to exchanging heat with the first stream. The cryogenic fluid can be vaporized and heated to a minimum temperature of at least about −6.67° C., and more preferably to a minimum temperature of at least about 4.44° C.

Another such illustrative embodiment includes a method for vaporizing and heating a liquefied natural gas. The method comprises the steps of producing a heat exchange vapor from a heat exchange fluid that comprises propane; splitting the heat exchange vapor into a first heat exchange stream and a second heat exchange stream; reducing the pressure of the first heat exchange stream by using the first heat exchange stream as a working fluid in a power generating device; exchanging heat between the first heat exchange stream and the liquefied natural gas to at least partially vaporize the liquefied natural gas; exchanging heat between the second heat exchange stream and the partially vaporized liquefied natural gas to heat the vaporized liquefied natural gas to a minimum temperature; adjusting the pressure of one or more of the first heat exchange stream and the second heat exchange stream; and re-combining the first and second heat exchange streams to produce the heat exchange fluid. The high pressure heat exchange vapor can be produced from the heat exchange fluid by pumping the heat exchange fluid to a higher pressure and then heating the heat exchange fluid. The method can optionally include the step of increasing the pressure of the liquefied natural gas to a pressure of at least about 500 psig, prior to exchanging heat with the first stream. The liquefied natural gas can be vaporized and heated to a minimum temperature of at least about −6.67° C.

Yet another illustrative embodiment includes a method for vaporizing and heating a cryogenic fluid. The methods comprises the steps of producing a heat exchange vapor from a heat exchange fluid; splitting the heat exchange vapor into a first heat exchange stream and a second heat exchange stream; exchanging heat between the first heat exchange stream and a cryogenic fluid to at least partially vaporize the cryogenic fluid; exchanging heat between the second heat exchange stream and the partially vaporized cryogenic fluid to heat the vaporized cryogenic fluid to a minimum temperature; adjusting the pressure of one or more of the first heat exchange stream and the second heat exchange stream; and re-combining the first and second heat exchange streams to produce the heat exchange fluid. In such a method, the heat exchange vapor can comprise propane and the cryogenic fluid can comprise liquefied natural gas. In such an embodiment, the pressure of one or more of the first and second heat exchange streams can be adjusted by reducing the pressure of the second heat exchange stream after exchanging heat with the partially vaporized cryogenic fluid.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

### DETAILED DESCRIPTION OF THE FIGURES

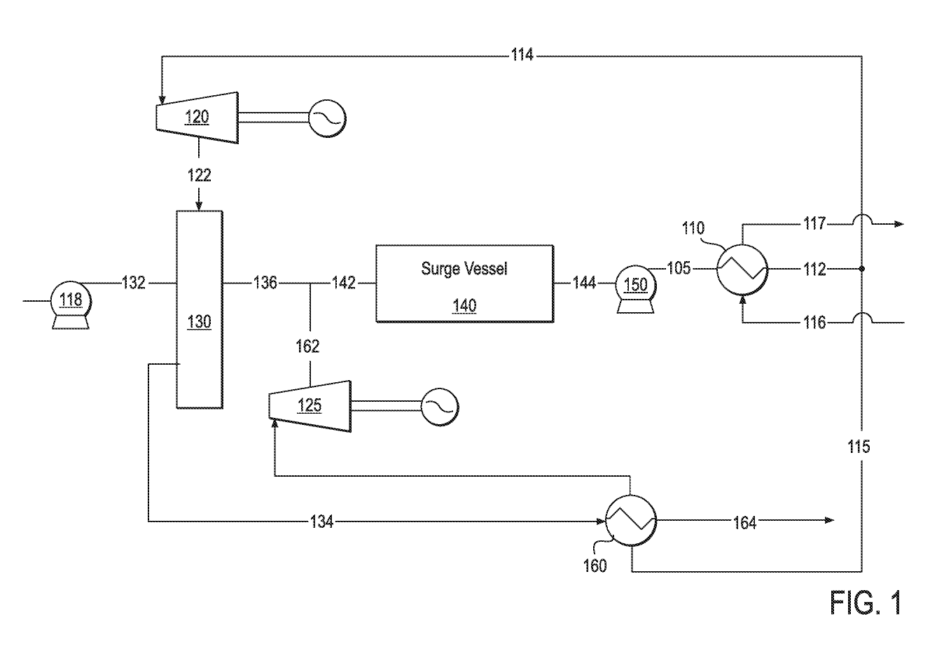

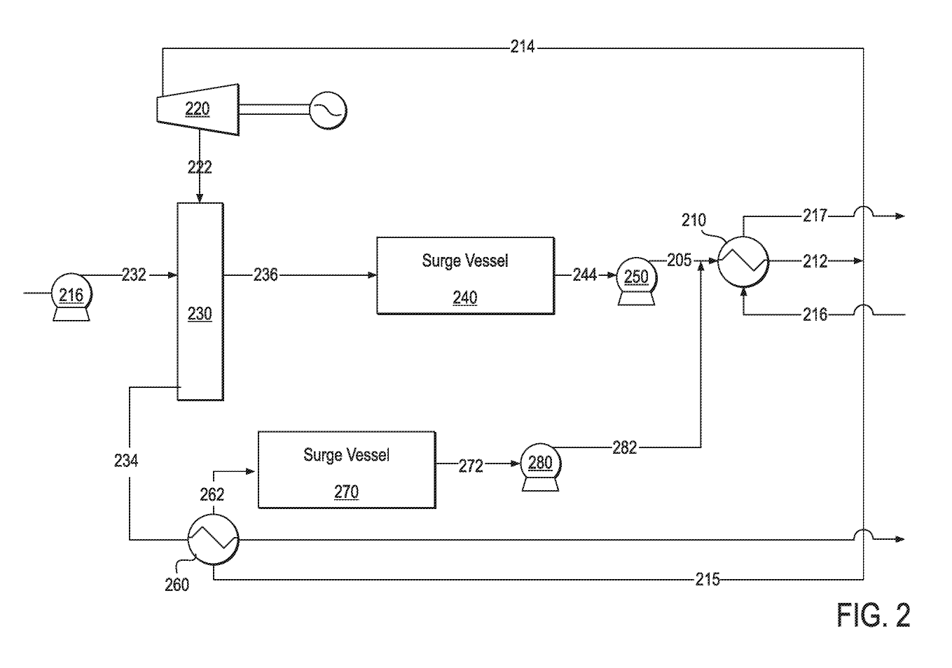

In the embodiment illustrated in FIGS. 1 and 2, the cryogenic fluid is LNG and the heat exchange fluid is propane.

Surge vessel 140 is a tank or other suitable container for holding a reserve of propane in its liquid phase. The propane is directed through line 144 to pump 150 where it is pumped to a pressure between about 90 psig and 110 psig. The propane is then directed through line 105 to heat exchanger 110 where it exchanges heat with a heated stream of cooling water from a refinery to produce a propane vapor having a temperature between about −17.78° C. and about 37.78° C. The cooling water has an inlet temperature in line 116 between about 20° C. and about 40° C. and an outlet temperature in line 117 of between about 4.44° C. and about 30° C. The propane vapor exits heat exchanger 110 through line 112 and is split into first and second streams that flow through lines 114 and 115, respectively.

Where an objective is to generate more power or extract more work from the heat exchange fluid, more heat will be transferred to the propane in heat exchanger 110. In such an embodiment, line 116 would contain a heated fluid such as steam from a boiler or exhaust gases from a furnace or combustor that would exchange heat with the propane in exchanger 110. The temperatures of such heated fluids will exceed about 40° C. and could be greater than about 120° C. depending on pressure conditions.

As illustrated, the multiple streams include a first heat exchange stream that is directed through line 114 to expansion turbine 120 where the first heat exchange stream serves as the working fluid to produce power. The expansion of the propane vapor reduces its temperature to between about −17.78° C. and about 10° C. and its pressure to between about 2 psig and about 20 psig. The propane exiting turbine 120 flows through line 122 to vaporizer 130 where it exchanges heat with the LNG flowing from line 132. Line 132 is preferably connected to a storage tank (not shown) that contains the LNG with intermediate pump 118 increasing the pressure of the LNG. The stored LNG is held at ambient or low pressure and is directed to pump 118 upstream of vaporizer 130 where the pressure of the LNG can be elevated to the desired pressure. The LNG flowing through vaporizer 130 is warmed to a temperature between about

−73.33° C. and about −28.89° C., at least partially vaporizing the LNG. Due to heat exchange with the LNG in vaporizer 130, the first heat exchange stream is cooled to a temperature between about −51.11° C. and about −17.78° C., at which the propane condenses and is directed out of the vaporizer.

The partially vaporized LNG is directed out of the vaporizer through line 134 to heat exchanger 160 where it exchanges heat with the second heat exchange stream in line 115. The vaporized natural gas exiting heat exchanger 160 has a temperature of at least about −6.67° C. and about 26.67° C., and depending on pressure, may be ready for introduction into a natural gas distribution pipeline. The propane flowing through heat exchanger 160 is subcooled by the partially vaporized natural gas to a temperature between about −45.56° C. and about −23.33° C. The second heat exchange stream is then directed to expansion turbine 125 where it is expanded to produce power and reduce the pressure of the propane. The step down in pressure condenses the second stream to a liquid that can be recombined with the first heat exchange stream in line 136. The recombined heat exchange fluid is directed through line 142 to the surge vessel 140.

The embodiment illustrated in FIG. 2 is similar to that of FIG. 1 wherein the cryogenic fluid is LNG, the heat exchange fluid is propane and the heating medium is a heated stream of cooling water from a refinery.

Liquid propane is held in surge vessel 240 and increased in pressure by pump 250 to a pressure of at least about 90 psig to yield a high pressure propane. This high pressure propane is combined with propane from line 282 and the re-combined high pressure propane is directed through line 205 to heat exchanger 210 where it exchanges heat with a heated stream of cooling water to produce a high pressure propane vapor having a temperature of at least about

−17.78° C. The high pressure propane vapor exits heat exchanger 210 through line 212 and is split into first and second streams that flow through lines 214 and 215, respectively.

The first stream is directed through line 214 to expansion turbine 220. The first stream, which comprises a high pressure propane vapor, serves a working fluid in turbine 220. Within turbine 220, the expansion of the high pressure propane vapor produces power and reduces the temperature and pressure of the propane. The propane exiting turbine 220 through line 222 flows to vaporizer 230 where it exchanges heat with the LNG flowing from line 232. Line 232 is preferably connected to pump 218, which is connected at its inlet to a storage tank (not shown) that contains LNG. Pump 218 increases the pressure of the LNG upstream from vaporizer 230.

Due to heat exchange with the LNG in vaporizer 230, the first heat exchange stream of propane is cooled and condensed to liquid and directed to surge vessel 240 through line 236. The LNG flowing through vaporizer 230 is warmed by the propane to a temperature of at least about −73.33° C. at least partially vaporizing the LNG. The partially vaporized LNG flows out of the vaporizer through line 234 to heat exchanger 260 where it exchanges heat with the second heat exchange stream from line 215. The propane flowing through heat exchanger 260 is subcooled and at least partially condensed by the partially vaporized natural gas. The second heat exchange stream is then directed to surge vessel 270 and subsequently to pump 280 where the pressure of the second heat exchange stream can be increased to that of the first stream before recombining the streams and vaporizing the propane in heat exchanger 210.

What is claimed is:

1. A method for vaporizing and heating a cryogenic fluid, the method comprising the steps of:
producing a high pressure heat exchange vapor from a heat exchange fluid;
splitting the high pressure heat exchange vapor into a first heat exchange stream and a second heat exchange stream;
reducing a pressure of the first heat exchange stream by using the first heat exchange stream as a working fluid in a power generating device;
exchanging heat between the first heat exchange stream and a cryogenic fluid to at least partially vaporize the cryogenic fluid;
exchanging heat between the second heat exchange stream and the partially vaporized cryogenic fluid to heat the partially vaporized cryogenic fluid to a minimum temperature;
adjusting the pressure of one or more of the first and second heat exchange streams; and
re-combining the first and second heat exchange streams to produce the heat exchange fluid.

2. The method of claim 1, wherein producing the high pressure heat exchange vapor from the heat exchange fluid comprises one or more of pumping and heating the heat exchange fluid.

3. The method of claim 2, wherein producing the high pressure heat exchange vapor comprises pumping the heat exchange fluid to a higher pressure and then heating the heat exchange fluid.

4. The method of claim 1, wherein the step of adjusting the pressure of one or more of the first and second heat exchange streams comprises one or more of:
increasing the pressure of the first heat exchange stream;
reducing the pressure of the second heat exchange stream; and
increasing the pressure of the second heat exchange stream.

5. The method of claim 4, wherein the step of adjusting the pressure of one or more of the first stream and the second stream comprises reducing the pressure of the second stream.

6. The method of claim 1, wherein the cryogenic fluid comprises liquefied natural gas.

7. The method of claim 1, wherein the heat exchange fluid comprises a hydrocarbon having about 1 to about 6 carbon atoms per molecule, a halogenated carbon, or mixtures thereof.

8. The method of claim 8, wherein heat exchange fluid comprises one or more of ethane, propane, butane, ethylene and propylene.

9. The method of claim 1, wherein the high pressure heat exchange vapor is at a pressure of at least about 60 psig.

10. The method of claim 9, wherein the high pressure heat exchange vapor is at a temperature of at least about 4.44° C.

11. The method of claim 1, wherein the minimum temperature is at least about −6.67° C.

12. The method of claim 12, wherein the minimum temperature is at least about 4.44° C.

13. The method of claim 1, further comprising the step of increasing the pressure of the cryogenic fluid to a pressure of at least about 500 psig, prior to exchanging heat with the first heat exchange stream.

14. The method of claim 14, wherein the pressure of the cryogenic fluid is increased to a pressure of at least about 1000 psig.

15. A method for vaporizing and heating a liquefied natural gas, the method comprising the steps of:
producing a heat exchange vapor having a pressure of at least about 60 psig from a heat exchange fluid, the heat exchange fluid comprising propane;
splitting the heat exchange vapor into a first heat exchange stream and a second heat exchange stream;
reducing the pressure of the first heat exchange stream by using the first heat exchange stream as a working fluid in a power generating device;
exchanging heat between the first heat exchange stream and liquefied natural gas to at least partially vaporize the liquefied natural gas;
exchanging heat between the second heat exchange stream and the partially vaporized liquefied natural gas to heat the vaporized liquefied natural gas to a minimum temperature;
adjusting the pressure of one or more of the first heat exchange stream and the second heat exchange stream; and
re-combining the first and second heat exchange streams to produce the heat exchange fluid.

16. The method of claim 16, further comprising the step of increasing the pressure of the liquefied natural gas to a pressure of at least about 500 psig, prior to exchanging heat with the first heat exchange stream.

17. The method of claim 16, wherein producing a high pressure heat exchange vapor comprises one or more of pumping and heating the heat exchange fluid.

18. The method of claim 16, the minimum temperature is at least about −6.67° C.

19. The method of claim 16, wherein the step of adjusting the pressure of one or more of the first heat exchange stream and the second heat exchange stream comprises one or more of:
increasing the pressure of the first heat exchange stream;
reducing the pressure of the second heat exchange stream; and
increasing the pressure of the second heat exchange stream.

20. A method for vaporizing and heating a cryogenic fluid, the method comprising the steps of:
producing a heat exchange vapor having a pressure of at least about 60 psig from a heat exchange fluid;
splitting the heat exchange vapor into a first heat exchange stream and a second heat exchange stream without substantially dropping the pressure in the first or second heat exchange streams from that of the heat produced exchange vapor;
reducing the pressure of the first heat exchange stream;
exchanging heat between the first heat exchange stream and a cryogenic fluid to at least partially vaporize the cryogenic fluid;
exchanging heat between the second heat exchange stream and the partially vaporized cryogenic fluid to heat the vaporized cryogenic fluid to a minimum temperature;
adjusting the pressure of one or more of the first and second heat exchange streams; and
re-combining the first and second heat exchange streams to produce the heat exchange fluid.

21. The method of claim 21, wherein the heat exchange fluid comprises propane and the cryogenic fluid comprises liquefied natural gas.

22. The method of claim 21, wherein the step of adjusting the pressure of one or more of the first and second heat exchange streams comprises reducing the pressure of the second heat exchange stream after exchanging heat with the partially vaporized cryogenic fluid.

23. The method of claim 23 further comprising the step of increasing the pressure of the second heat exchange stream prior to re-combining the first and second heat exchange streams to produce the heat exchange fluid.
